(19) United States
(12) Patent Application Publication
(10) Pub. No.: US 2002/0119748 A1
(43) Pub. Date: Aug. 29, 2002

(54) METHOD AND APPARATUS FOR PROVIDING A PASSIVE CELLULAR TELEPHONE REPEATER

(76) Inventors: ELDON A. PRAX, HURST, TX (US); MICHAEL J. MAGUIRE, SACHSE, TX (US)

Correspondence Address: MERCHANT & GOULD PC, P.O. BOX 2903, MINNEAPOLIS, MN, 55402-0903, US

(21) Appl. No.: 09/339,592

(22) Filed: Jun. 24, 1999

(51) Int. Cl. H04B 7/14

(52) U.S. Cl. 455/7

(57) ABSTRACT

An apparatus and method for providing a passive wireless repeating system in order to provide an increased wireless signal inside an enclosed space. The apparatus and method comprise mounting a directional donor antenna outside an enclosed space to provide a clear line of sight to a source of wireless signals, mounting a serving antenna within the enclosed space to provide an increased wireless signal inside an enclosed space, and an electrical connection connect between the donor antenna and the serving antenna. The serving antenna is mounted within an enclosed space to provide occupants of the enclosed space with reception of the cellular signals.

### FIELD OF THE INVENTION

This invention relates in general to a method and apparatus for providing cellular telephone and PCS reception within closed spaces, and more particularly to a method and apparatus to provide a passive repeater for increasing the signal strength for PCS and cellular telephone systems (cellular and PCS a/k/a wireless phones) within buildings and similar closed spaces.

### BACKGROUND OF THE INVENTION

Because of the recent increase in the usage of cellular telephones, it can be seen that there is a need for providing adequate signal strength to locations in which wireless telephones are likely to be making calls. As more people use, and ultimately become dependent upon, wireless telephones, locations in which weak, or non-existent, signals from wireless telephone systems are present become locations where `an increasing number of people will begin to avoid.

This particular problem is even more pronounced when digital wireless systems are considered. Because digital wireless telephone systems, and closely related cellular-based digital communications networks, are likely to increase for the foreseeable future, a need exists to reduce or eliminate these locations of weak signal strength to permit wireless communication users to enjoy the uninterrupted use of these communication services.

It can also be seen that there is a need for eliminating the locations of weak signal strength for wireless telephone systems in a manner that does not require the use of on-site resources. At present, the wireless telephone service reception may experience a significant decrease is observable signal strength when users enter many buildings. Business establishments catering to pedestrian customers are prone to such drops in receivable signal strength depending upon a host of factors beyond the control of the business establishment. Owners of retail business establishments such as stores and restaurants would especially desire to eliminate reception problems for their customers as long as the solution can be easily and inexpensively installed. Because many of these establishments lease space from property owners who may restrict the amount and type of equipment which may be installed, it is desirable that any solution to this problem be as unintrusive as possible, that the solution not require on-site resources such as power and special environmental conditions, and that the solution be as inexpensive as possible to install and utilize. The present invention addresses all of the above problems discussed above in a simple and inexpensive solution.

### SUMMARY OF THE INVENTION

To overcome the limitations in the prior art described above, and to overcome other limitations that will become apparent upon reading and understanding the present specification, the present invention discloses a method and apparatus for providing a passive repeater for increasing the signal strength for wireless telephone systems within buildings and similar closed spaces.

The present invention solves the above-described problems by providing an apparatus for providing a passive wireless repeating system in order to provide an increased wireless signal inside an enclosed space. The apparatus comprising a directional donor antenna having a clear line of sight to a source of wireless signals, a serving antenna, and an electrical connection between the donor antenna and the serving antenna. The serving antenna is mounted within an enclosed space to provide occupants of the enclosed space with reception of the cellular signals.

Other embodiments of a system in accordance with the principles of the invention may include alternative or optional additional aspects. One such aspect of the present invention is a method for providing a passive wireless repeating system in order to provide an increased cellular signal inside an enclosed space. The method comprises mounting a directional donor antenna outside the enclosed space to provide a clear line of sight to a source of wireless signals, mounting a serving antenna within the enclosed space to provide occupants of the enclosed space with reception of the cellular signals, and providing an electrical connection connect between the donor antenna and the serving antenna.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a system block diagram of a passive cellular repeater according to one embodiment of the present invention;

FIG. 2 illustrates a block diagram of a passive cellular repeater mounted upon a building according to another embodiment of the present invention; and

FIG. 3 illustrates a block diagram of a passive cellular repeater comprising a plurality of antennae components in multiple locations according to another embodiment of the present invention.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention. The present invention provides a passive repeater for increasing the signal strength for wireless telephone systems within buildings and similar closed spaces.

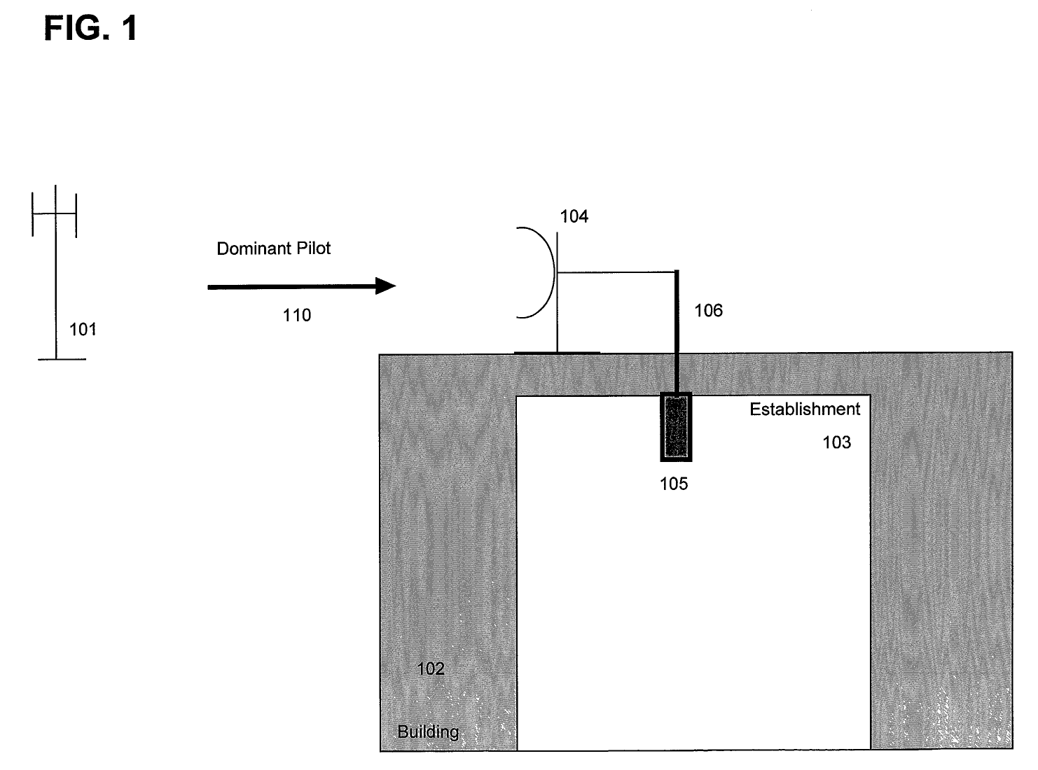

FIG. 1 illustrates a system block diagram of a passive wireless telephone repeater system according to the one embodiment of the present invention. The system comprises a donor antenna 104 mounted on top of a building 102. The donor antenna 104 is directed towards a wireless telephone transmitting cell site 101. The donor antenna 104 is preferably a parabolic microwave antenna capable of capturing and passively amplifying the Dominant Pilot at 110 that contains the wireless telephone signals.

The donor antenna receives and passes the wireless signal into the building 102 to provide a passively amplified signal within establishment 103. The signal is sent between the donor antenna 104 and a serving antenna unit 105 using a audible connection 106. The serving antenna passively retransmits the wireless signal received by the donor antenna 104 within the establishment 103. This system increases the signal strength of the dominant pin 110 within establishment 103.

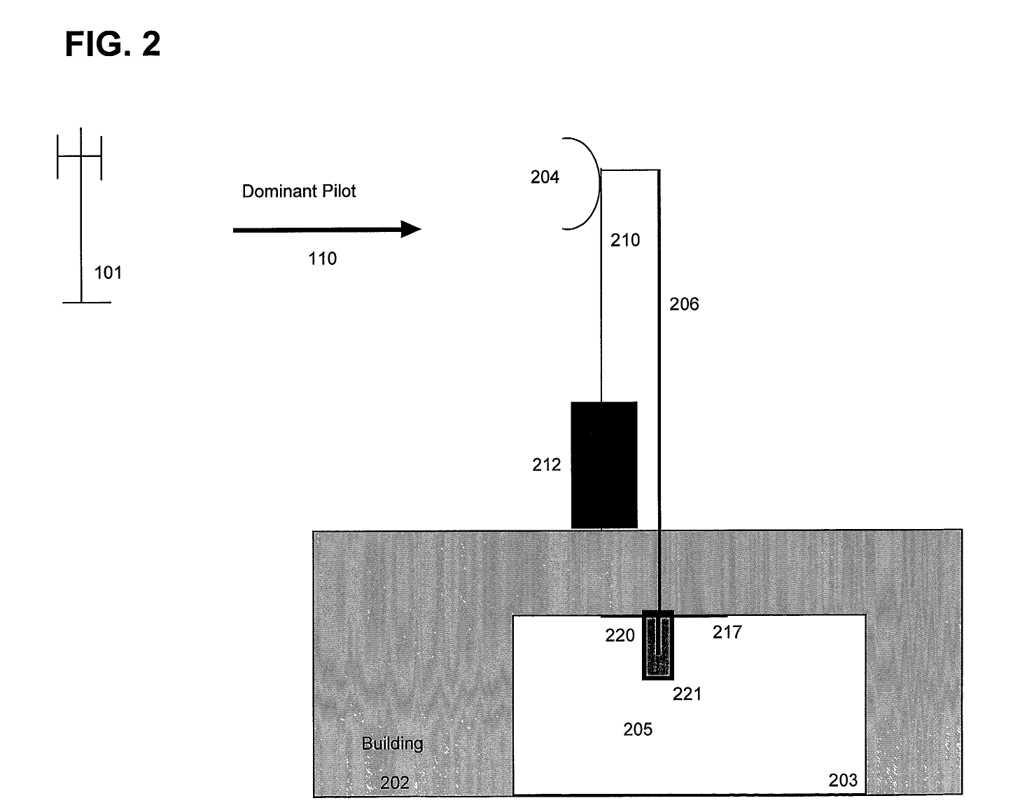

FIG. 2 illustrates a block diagram of a passive wireless repeating system according to another embodiment of the present invention. A donor antenna 204 is mounted above building 202 using a rooftop pole 210. The rooftop pole 210 may be a free standing pole approximately ten feet high having a diameter of between two and four inches. The free standing pole may be inserted within a support base 212 to provide the pole with the necessary stability to hold the donor antenna 204 above the rooftop. One possible embodiment for this support pole can be a quick mount system manufactured by tower structures of Chula Vista, Calif. The support base 212 comprises three section plastic water tanks approximately seven feet in diameter which when filled with water provide the necessary mass to hold the support pole 210 stationary. In the event that plastic water tanks contain water, a glycol based antifreeze may need to be added to these tanks in climates in which water may freeze. The donor antenna 204 must possess a clear line of sight to the source of the wireless signal. The manner in which the donor antennae 204 is mounted onto the building 2-3 will vary from site to site, and will depend upon the requirements necessary to obtain the clear line of sight to this signal source.

The electrical signal passes from donor antenna 204 to serving antenna 205 using a electrical connection 206. In one particular embodiment, this electrical connection 206 may comprise a coaxial cable having connectors at either end. In one embodiment, this coaxial cable may comprise a loss coaxial cable Part No. LDF4 manufactured by the Andrew Corporation.

In one embodiment, the donor antenna may comprise a four foot parabolic microwave antenna. This antenna should have an effective band between 1.7 and 2.11 GHz (for PCS applications—other cellular applications will vary). The antenna in this embodiment has a mid-band gain of 49 dBi with a beam width of 9.0°. The antenna should also have a feed input flange of approximately ⅞ of an inch EIA. One such parabolic antenna is manufactured by the Radio Frequency Systems, Inc. of Atlanta, Ga. Antennas having similar system characteristics would be an acceptable substitute for this particular manufacturer's antenna.

The electrical connection coaxial cable 206 connects the donor antenna 204 with the serving antenna located within the building 203. The serving antenna comprises a ground plate 217 which is connected to an earth ground at the building of installation, a driven element 220, and a surrounding support structure 221. In one particular embodiment, the driving element can be a rural telephone antenna manufactured by the Andrew Corporation. This antenna contains three reflecting panels which utilize an imaging theory to achieve maximum signal gain.

This antenna should be an Andrew Rural Telephone Tri-Corner having a band of 1.8−2.0 GHz (for PCS applications—other cellular applications will vary) and a gain of 4.5 dBi. The driven element has the approximate length of six inches and an omni beam width. The driven element is located within the support structure 221 which in one embodiment is constructed of a PVC pipe of at least equal if not greater length. The coaxial cable 206 is directly connected to the driving element 220 to permit the received signal to pass directly into the establishment 203.

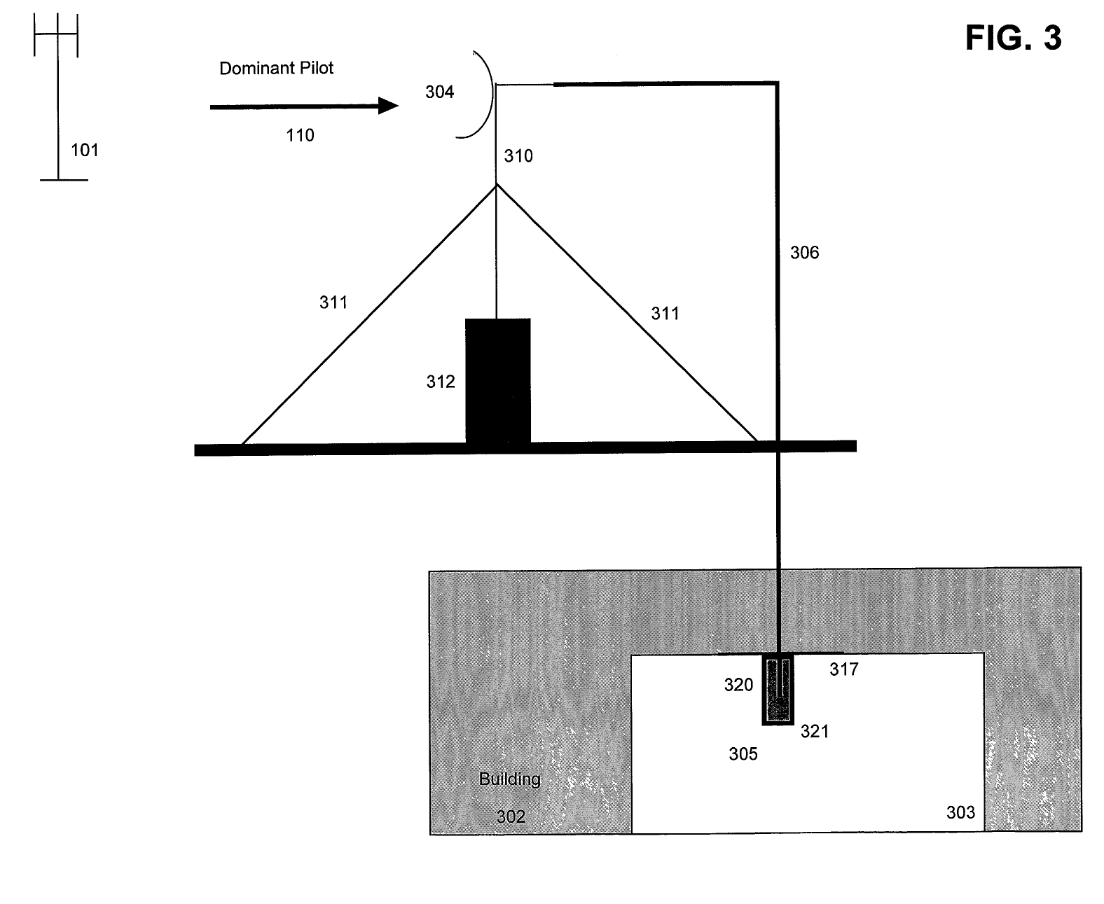

FIG. 3 illustrates yet another embodiment of the passive repeater system in which the antenna system is mounted external to the building. In this embodiment, the antenna 304 is mounted upon a hole 310 which may have a base support 312 depending upon the height that the antenna 304 must be raised, support guide wires 311 may be needed to support and stabilize the support pole 310. The signal received by the donor antenna 304 passes through an electrical connection 306. The electrical connection 306 is again coaxial cable used to connect the donor antenna with the serving antenna 305. The serving antenna 305 is located within the establishment 303 and comprises the ground plate 317, a driving element 320, and a support structure 321.

When installing any of the embodiments of the passive repeater system, it is desirable that the electrical connection 206 be kept as short as possible. The particular method in which the electrical connection in this coaxial cable is routed between the donor antenna 204 and the serving antenna unit 205 will vary from installation to installation. In addition, the means in which the connection and the coaxial cable penetrates through the rooftop of the building into the closed space within the establishment is also not particularly significant as long as a short and direct path between the donor antenna and the serving antenna can be obtained and a coaxial cable routed there between, the present invention may be practiced.

When installing this system, the mounting structure comprising the support base 212 and support bolt 210 are mounted on the building. The donor antenna unit 204 is then mounted on hole and directed towards the source of cellular telephone cell site. Using a spectrum analyzer, the donor antenna was then “dialed” into the strongest serving face. The donor antenna 204 is then adjusted to get the maximum received pilot signal at the end of foam jumper. Next, the connection cable 206 is connected directly to the donor antenna dipole via a N connector.

Within the store, the grounding plate 217 is mounted in the ceiling in the establishment in which the signal is to be directed. The driving element 220 is mounted to the grounding plate with the second end of the electrical connection 206 connected to this combination. The grounding plate 217 is connected to an earth grounded building through the building's electrical system. The driving element is contained within the PVC support element 221 to have the entire serving antenna 205 mounted just below the ceiling of the establishment 203. Once this installation is complete, the measurements of the dominant pilot are measured throughout the establishment 203. This may be accomplished using both a wireless telephone in a test mode and the spectrum analyzer. From these measurements, one can calculate a serving cell radius using the Friis transmission formula. This formula is defined:

Friis Transmission Formula: Pᵣ=Pₜ(GₜGᵣλ²/4π²)

where:

Pᵣ=Power at serving antenna dBm

Pₜ=Power at donor antenna dBm

Gₜ=Gain at serving antenna dB

Gₜ=Gain at donor antenna dB

General requirement for employing a passive repeater according to the present invention:

a) Power transferred from the donor antenna to the server must be of reasonable level to ensure the entire store is covered within an adjusted link budget. Forward link power must not deviate below −104° dBm within the coverage area to maintain a call.

b) Minimum cable lengths. The maximum cable length allowed is related to the received signal strength at the donor antenna. Total cable runs exceeding 100 feet should be avoided.

c) Donor antenna must have a clear line of site to the serving sector. This must not be blocked by seasonal changes or new construction. The antenna must have a mounting point available that will not misalign under weathering or stress.

### EXAMPLE

The available power at the serving antenna can be calculated from the equation below.

Pt+Gt−Ls=Pr

Pt=Power at donor antenna dBm

Gt=Gain at donor antenna dB

Ls=Cable and connector losses dB

Pr=Power at serving antenna connector dBm

Pr must be above −51 dBm to have an effective radius approaching 10 meters with 10 dB or inbuilding clutter. The energy at the inbuilding serving antenna can be measured by a spectrum analyzer. The power level can be introduced into the follow equation to determine maximum distance of operation. From the power at serving antenna the serving radius can be determined. Setting Pmobile to −104 for minimum operation level and solving for radius[r].

20Log[r]=Pt+Gt−Pmobile−20Log[f]−32.4476

Pt=Power delivered to the inbuilding antenna in dBm

Gt=Gain of the inbuilding antenna dBi

Pmobile=mobile receive power

r=serving radius in meters

f_{GHz}=frequency of transmitter (BTS)

If we assume f is 1.9 GHz the equation can be simplified to

20Log[r]=Pt+Gt+66

and the maximum serving radius in meters can be found. The RF engineering team performing the analysis should utilize a buffer margin for body loss and clutter within the store. The following worksheet can be modified to suit individual needs.

Inbuilding Work Sheet

| | | |
|---|---|---|
| Power at donor antenna | dBm | −51.000 |
| Gain of donor antenna | dBi | 20.000 |
| Cable and connector loss | dB | 5.000 |
| Gain of serving antenna | dBi | 2.000 |
| Inbuilding Clutter loss | dB | 10.000 |
| Mobile receiver sensitivity | −104 dBm | −104.000 |
| Maximum Radius | meters | 10.000 |
| Power at serving antenna | dBm | −36.000 |

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. An apparatus for providing a passive wireless repeating system in order to provide an increased cellular signal inside an enclosed space, the apparatus comprising:
a directional donor antenna having a clear line of sight to a source of cellular signals;
a serving antenna; and
an electrical connection connect between the donor antenna and the serving antenna;
wherein the serving antenna is mounted within an enclosed space to provide occupants of the enclosed space with reception of the cellular signals.

2. The apparatus according to claim 1, wherein the directional donor antenna is a parabolic microwave antenna having a diameter of at least 40 inches.

3. The apparatus according to claim 2, wherein the parabolic microwave antenna possesses a gain of at least 24 dBi over a band of 1.7-2.11 GHz.

4. The apparatus according to claim 1, wherein the serving antenna comprises:
a ground plate;
a non-conductive housing; and
a driving element connected to the ground plate and the electrical connection and being configured to extend within the non-conductive housing.

5. The apparatus according to claim 4, wherein the driving element possesses a gain of at least 4 dBi over a band of 1.8-2.0 GHz.

6. The apparatus according to claim 4, wherein the serving antenna is mounted in the ceiling of the enclosed space such that the non-conductive housing and the driving element extend downward from the ceiling into the enclosed space.

7. The apparatus according to claim 4, wherein the electrical connection comprises a coaxial cable.

8. The apparatus according to claim 7, wherein the coaxial cable comprises a flexible cable such that the cable may be routed inside the enclosed space to effectuate the connection of the donor element to the driving element.

9. An apparatus for providing a passive wireless repeating system in order to provide an increased cellular signal inside an enclosed space, the apparatus comprising:
a directional donor antenna having a clear line of sight to a source of cellular signals, the directional donor antenna comprises a parabolic microwave antenna having a diameter of at least 40 inches;
a serving antenna comprising a ground plate, a non-conductive housing, and a driving element connected to the ground plate and being configured to extend within the non-conductive housing; and
an electrical connection connect between the donor antenna and the driving element of the serving antenna;
wherein the serving antenna is mounted within an enclosed space to provide occupants of the enclosed space with reception of the cellular signals;
the electrical connection comprises a coaxial cable;
the coaxial cable comprises a flexible cable such that the cable may be routed inside the enclosed space to effectuate the connection of the donor element to the driving element.

10. An method for providing a passive wireless repeating system in order to provide an increased cellular signal inside an enclosed space, the method comprising:
mounting a directional donor antenna outside the enclosed space to provide a clear line of sight to a source of cellular signals;
mounting a serving antenna within the enclosed space to provide occupants of the enclosed space with reception of the cellular signals; and
providing an electrical connection connect between the donor antenna and the serving antenna.

11. The method according to claim 10, wherein the directional donor antenna is a parabolic microwave antenna having a diameter of at least 40 inches.

12. The method according to claim 11, wherein the parabolic microwave antenna possesses a gain of at least 24 dBi over a band of 1.7-2.11 GHz.

13. The method according to claim 10, wherein the serving antenna comprises:
a ground plate;
a non-conductive housing; and
a driving element connected to the ground plate and the electrical connection and being configured to extend within the non-conductive housing.

14. The method according to claim 4, wherein the driving element possesses a gain of at least 4 dBi over a band of 1.8-2.0 GHz.

15. The method according to claim 4, wherein the serving antenna is mounted in the ceiling of the enclosed space such that the non-conductive housing and the driving element extend downward from the ceiling into the enclosed space.

16. The method according to claim 4, wherein the electrical connection comprises a coaxial cable comprising a flexible cable such that the cable may be routed inside the enclosed space to effectuate the connection of the donor element to the driving element.

17. An method for providing a passive wireless repeating system in order to provide an increased cellular signal inside an enclosed space, the apparatus comprising:
mounting a directional donor antenna outside the enclosed space to provide a clear line of sight to a source of cellular signals, the directional donor antenna comprises a parabolic microwave antenna having a diameter of at least 40 inches;
mounting a serving antenna within the enclosed space to provide occupants of the enclosed space with reception of the cellular signals, the erving antenna comprising a ground plate, a non-conductive housing, and a driving element connected to the ground plate and being configured to extend within the non-conductive housing; and
providing an electrical connection connect between the donor antenna and the driving element of the serving antenna;
wherein the serving antenna is mounted within an enclosed space to provide occupants of the enclosed space with reception of the cellular signals;
the electrical connection comprises a coaxial cable;
the coaxial cable comprises a flexible cable such that the cable may be routed inside the enclosed space to effectuate the connection of the donor element to the driving element.

18. An apparatus for providing a passive cellular repeating system in order to provide an increased cellular signal inside an enclosed space, the apparatus comprising:
means for mounting a directional donor antenna outside the enclosed space to provide a clear line of sight to a source of cellular signals, the directional donor antenna comprises a parabolic microwave antenna having a diameter of at least 40 inches;
means for mounting a serving antenna within the enclosed space to provide occupants of the enclosed space with reception of the cellular signals, the serving antenna comprising a ground plate, a non-conductive housing, and a driving element connected to the ground plate and being configured to extend within the non-conductive housing; and
means for providing an electrical connection connect between the donor antenna and the driving element of the serving antenna; and
wherein the serving antenna is mounted within an enclosed space to provide occupants of the enclosed space with reception of the cellular signals;
the electrical connection comprises a coaxial cable;
the coaxial cable comprises a flexible cable such that the cable may be routed inside the enclosed space to effectuate the connection of the donor element to the driving element.
